(19) United States
(12) Patent Application Publication
(10) Pub. No.: US 2008/0058151 A1
(43) Pub. Date: Mar. 6, 2008

(54) Cam gear for mechanical locking differential

(75) Inventor: Kent M. Curtis, Battle Creek, MI (US)

Correspondence Address: EATON CORPORATION;EATON CENTER, 1111 SUPERIOR AVENUE, CLEVELAND, OH, 44114, US

(73) Assignee: KENT M. CURTIS

(21) Appl. No.: 11/515,275

(22) Filed: Sep. 1, 2006

(51) Int. Cl. F16H 48/06; F16H 48/14

(52) U.S. Cl. 475/232

(57) ABSTRACT

An improved differential gear mechanism is characterized by a cam mechanism including a first cam member fixed to rotate with one of said output gears and a second cam member free to rotate relative to said first cam member and said output gear. The first cam member defines a first cam surface and the second cam member defines a second cam surface engagable with the first cam surface to impart movement of the second cam member along axis. The first cam member comprises a powdered metal component, which provides consistency in the cam surface profile and eliminates the substantial capital equipment needed to machine the cam surface.

### BACKGROUND OF THE DISCLOSURE

The present invention relates to differential gear mechanisms, and more particularly, to such mechanisms that include a cam mechanism for limiting differentiation. More specifically, the present invention relates to mechanisms of the type also referred to as “mechanical lockers”, i.e., locking differentials in which the locking function occurs in response to the operation of a mechanical device, as opposed to hydraulic actuation or electromagnetic actuation.

A conventional locking differential made by the assignee of the present invention utilizes a flyweight mechanism to initiate the lock-up of the differential clutch, wherein the flyweight mechanism then retards rotation of a cam plate relative to the differential input (i.e., the ring gear and differential case). Locking differentials of the type that utilize a flyweight mechanism to initiate clutch engagement are now well known, and may be made in accordance with the teachings of any one or more of U.S. Pat. Nos. 3,606,803; 5,484,347, and 6,319,166, all of which are assigned to the assignee of the present invention and incorporated herein by reference.

The locking differentials of the type made and sold commercially by the assignee of the present invention have been in widespread commercial usage for many years, and have performed in an extremely satisfactory manner. However, the current process of machining a cam surface into the side gear that engages the cam plate results in an undesirable amount of dimensional variation in the camming surfaces of a component largely responsible for the differential-limiting operation of the differential. This in turn creates inconsistency in the engagement quality and durability of the differential.

### BRIEF SUMMARY OF THE INVENTION

An improved differential gear mechanism is provided that includes a gear case defining a gear chamber, a differential gear set disposed in the gear chamber, and including at least one input gear and a pair of output gears defining an axis of rotation. A lock-up clutch is operable to retard differentiating action, and included is an actuating means for actuating the lock-up clutch. The lock-up clutch is operable between an engaged condition, effective to retard relative rotation between the gear case and the output gears, and a disengaged condition. The actuating means includes cam means operable to affect the engaged condition of the lock-up clutch, and retarding means operable to engage the cam means and retard rotation of one member of the cam means.

The improved differential gear mechanism is characterized by a cam mechanism including a first cam member fixed to rotate with one of said output gears and a second cam member free to rotate relative to said first cam member and said output gear. The first cam member defines a first cam surface and the second cam member defines a second cam surface engagable with the first cam surface to impart movement of the second cam member along an axis of the differential gear mechanism. The first cam member comprises a powdered metal component, which provides consistency in the cam surface profile and eliminates the substantial capital equipment needed to machine the cam surface in a conventional locking differential.

### BRIEF DESCRIPTION OF THE DRAWINGS

FIG. 1 is an axial cross-sectional view of a locking differential mechanism according to an embodiment of the present invention;

FIG. 2 is a perspective view of a first cam member and side gear of the locking differential mechanism of FIG. 1;

FIG. 3 is a second perspective view of a first cam member and side gear of the locking differential mechanism of FIG. 1;

FIG. 4 is an exploded perspective view of a first cam member and side gear of the locking differential mechanism of FIG. 1;

FIG. 5 is a cross-sectional view of the differential of FIG. 1 illustrating, in somewhat greater detail, the flyweight mechanism; and

FIG. 6 is a detail view of the flyweight mechanism and a lockout mechanism.

### DETAILED DESCRIPTION OF THE PREFERRED EMBODIMENT

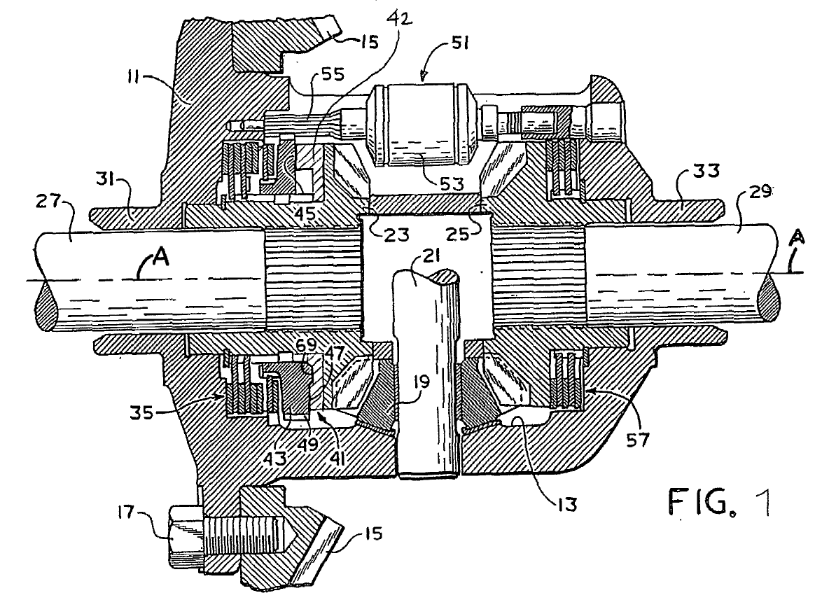

Referring now to the drawings, which are not intended to limit the invention, FIG. 1 is an axial cross-section of a locking differential gear mechanism of the type that may advantageously utilize the present invention. The differential gear mechanism as shown in FIG. 1 includes a gear case 11 that defines therein a gear chamber, generally designated 13. Torque input to the locking differential is typically by means of an input gear 15 (shown only in fragmentary view in FIG. 1). The input gear 15 (also referred to as a “ring gear”) is intended to be in toothed engagement with an input pinion gear (not shown in FIG. 1), which receives input drive torque from the vehicle driveline. The input gear 15 may be attached to the gear case 11 by means of a plurality of bolts 17.

Disposed within the gear chamber 13 is a differential gear set including a plurality of pinion gears 19 (only one of which is shown in FIG. 1), rotatably mounted on a pinion shaft 21 (only a portion of which is shown in FIG. 1). The pinion shaft 21 is secured to the gear case 11 by any suitable means, not shown herein. The pinion gears comprise the input gears of the differential gear set, and are in meshing engagement with a pair of side gears 23 and 25, which comprise the output gears of the differential gear set. The side gears 23 and 25 are in splined engagement with a pair of axle shafts 27 and 29, respectively. The gear case 11 includes annular hub portions 31 and 33, surrounding the axle shafts 27 and 29, respectively. Typically, bearing sets (not shown) are mounted on the hub portions 31 and 33 to provide rotational support for the differential gear mechanism, relative to the main, outer differential housing (also not shown herein).

During normal, straight-ahead operation of the vehicle, no differentiating action occurs between the left and right axle shafts 27 and 29, and the pinion gears 19 do not rotate relative to the pinion shaft 21. Therefore, the gear case 11, the pinion gears 19, the side gears 23 and 25, and the axle shafts 27 and 29 all rotate about an axis of rotation (A-A) of the axle shafts 27 and 29, as a solid unit.

Under certain operating conditions, such as when the vehicle is turning, or there is a slight difference in the size of the tires associated with the axle shafts 27 and 29, it is permissible for a certain amount of differentiating action to occur between the side gears 23 and 25, up to a predetermined level of speed difference. Above that predetermined level (e.g., above a difference of about 100 rpm between the side gears 23 and 25), indicating that a wheel spin-out is imminent, it is desirable to retard the relative rotation between each of the side gears 23 and 25 and the gear case 11, to prevent excessive differentiating action between the axle shafts 27 and 29.

In order to retard differentiating action, the differential gear means is provided with a lockup means for locking up the differential gear set, and an actuating means for actuating the lockup means. The general construction and operation of the lockup means and the actuating means are now well known in the art, and will be described only briefly herein. For a more detailed explanation of the lockup means and the actuating means, reference should be made to the above-incorporated patents, and further, to U.S. Pat. No. RE 28,004 and U.S. Pat. No. 3,831,462, both of which are assigned to the assignee of the present invention and incorporated by reference.

In the subject embodiment, the lockup means comprises a clutch pack, generally designated 35. As is now well known to those skilled in the art, the clutch pack 35 includes a plurality of outer clutch disks splined to the gear case 11, and a plurality of inner clutch disks splined to the side gear 23. Referring still to FIG. 1, the lock-up means further includes a cam mechanism, generally designated 41. As is well known to those skilled in the locking differential art, the primary function of the cam mechanism 41 is to effect movement of the clutch pack 35 from the disengaged condition, as shown in FIG. 1, to an engaged, “loaded” condition (not specifically illustrated herein). In the engaged condition, the clutch pack 35 is effective to retard relative rotation between the gear case 11 and the side gear 23, thus retarding and minimizing differentiating action between the side gears 23 and 25.

In an embodiment of the present invention, the cam mechanism 41 includes a first cam member 42 fixed to rotate with the side gear 23 by virtue of a splined interface, for example, and a second cam member 43 that is free to rotate relative to the first cam member 42 and the side gear 23. The first cam member 42 defines a first cam surface 45, and the second cam member 43 defines a second cam surface 47. The second cam member 43 also defines a set of external teeth 49, the function of which will be described subsequently.

During normal, straight-ahead operation of the vehicle, with little or no differentiating action occurring, the cam surfaces 45 and 47 remain in the neutral position shown in FIG. 1, with the second cam member 43 rotating with the first cam member 42 and the side gear 23, at the same rotational speed. Movement of the clutch pack 35 to the engaged condition is accomplished by retarding rotation of the second cam member 43, relative to the first cam member 42, to cause “ramping” of the cam surfaces 45 and 47. Such ramping results in axial movement of the second cam member 43, to the left in FIG. 1, thus initiating engagement of the clutch pack 35.

The cam-faced side gears in U.S. Pat. No. RE 28,004 and U.S. Pat. No. 3,831,462 typically have their cam profiles machined via machine tooled shaping or milling operations. As described above, this permits variation in machining consistency from one process to another and from one type of machining operation to another. This in turn creates inconsistency in the engagement quality and durability of the final product.

In the present invention, by contrast, the side gears 23, 25 comprise, for example, a machined forged component and the first cam member 42 comprises a powdered metal component. Manufacturing the first cam member 42 using powdered metallurgy eliminates or minimizes machining required in the prior art side gear cam surface, since the component is produced at, or close to, final dimensions. This feature provides consistency in the cam surface profile and eliminates the substantial capital equipment needed to machine the cam surface 45, resulting in a significant manufacturing cost savings.

In order to retard rotation of the second cam member 43 relative to the side gear 23, the locking differential gear mechanism includes a retarding mechanism, generally designated 51, which comprises the actuating means for actuating the lockup means. It should become apparent to those skilled in the art that within the scope of the present invention, many different configurations and types of retarding mechanisms may be utilized. In the subject embodiment, and by way of example only, the retarding mechanism 51 is of the flyweight type, illustrated and described in greater detail in the above-incorporated patents and herein below. The retarding mechanism 51 is mounted within the gear case 11 for rotation about its own axis, and includes a cylindrical flyweight portion 53. The retarding mechanism 51 further includes an externally geared portion 55, which is in engagement with the external gear teeth 49 of the cam member 43.

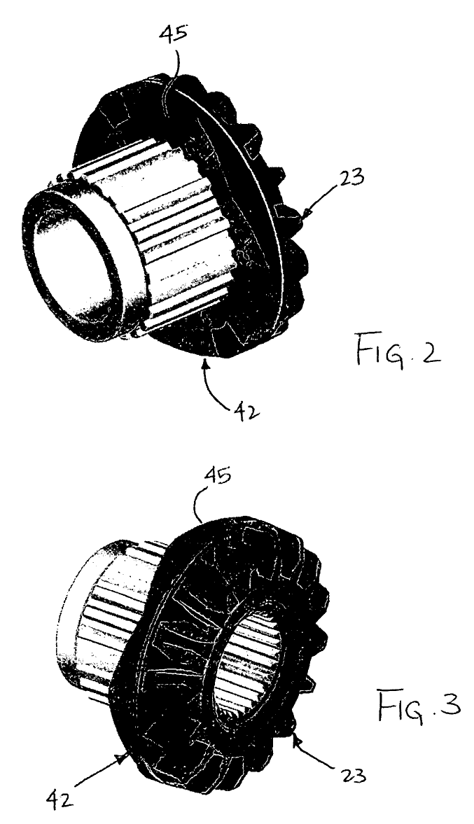

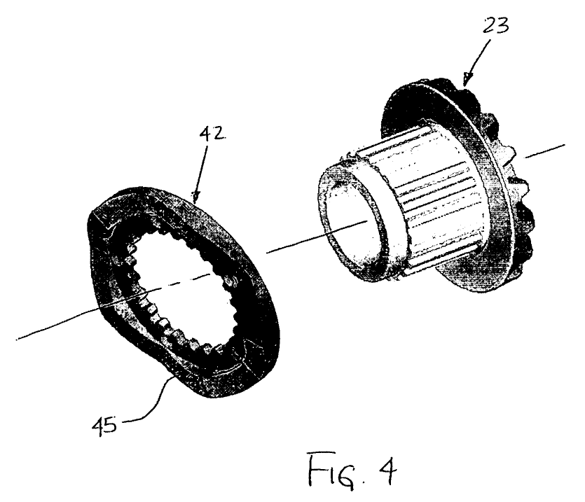

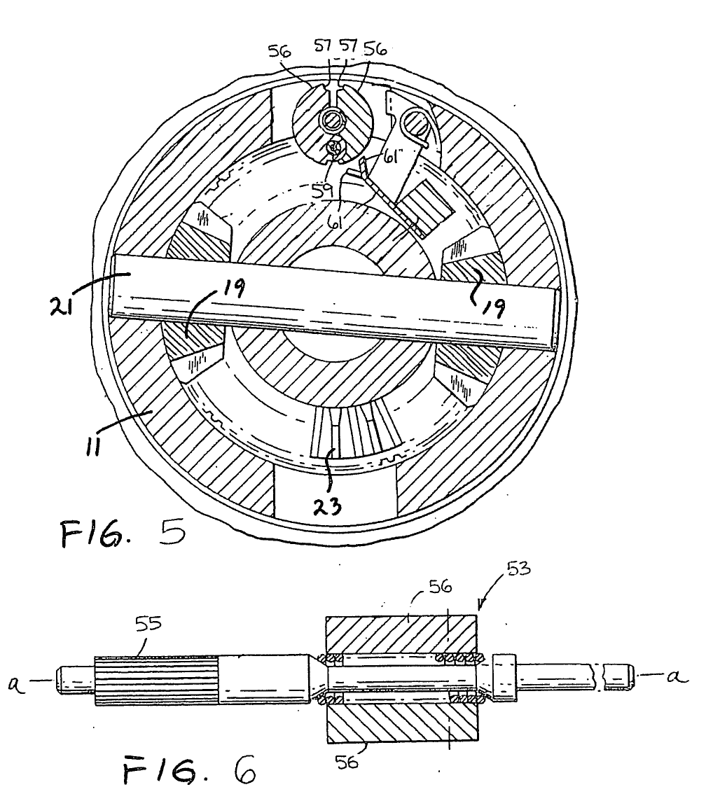

Flyweight portion 53 is rotatable about an axis (a-a), shown in FIG. 6, and oriented generally parallel to the axis of rotation (A-A), at a speed generally representative of the extent of the differentiating action. Flyweight portion 53 includes a pair of flyweight members 56 each defining a stop surface 57. The stop surface 57 is moveable from a retracted position (FIG. 2) to an extended position (not shown) in response to a predetermined extent of differentiating action. The flyweight member also defines a pivot portion 59 defining a pivot axis generally parallel to and spaced apart from the axis (a) of the flyweight portion 53. The stop surface 57 is generally oppositely disposed from the pivot axis. The actuating means includes a latch surface 61 positioned to engage the stop surface 57 when the stop surface is in the extended position.

During operation, if differentiating action begins to occur between the axle shafts 27 and 29, the side gear 23, first cam member 42 and second cam member 43 will begin to rotate in unison at a speed different than that of the gear case 11, causing the retarding mechanism 51 to begin to rotate about its axis (a-a) at a rotational speed which is a function of the extent of the differentiating action. As the speed of rotation of the retarding mechanism 51 increases, centrifugal force causes the flyweights 56 to move outward until one of the flyweight's stop surface 57 engages the latch surface 61, preventing further rotation of the retarding mechanism 51. When the retarding mechanism 51 stops rotating, the engagement of the geared portion 55 and the gear teeth 49 causes the second cam member 43 to rotate at the same speed as the gear case 11 (which is different than the speed of rotation of the side gear 23 and first cam member 42), resulting in ramping, and initializing of engagement of the clutch pack 35.

The invention has been described in great detail in the foregoing specification, and it is believed that various alterations and modifications of the invention will become apparent to those skilled in the art from a reading and understanding of the specification. It is intended that all such alterations and modifications are included in the invention, insofar as they come within the scope of the appended claims.

What is claimed is:

1. A differential gear mechanism comprising a gear case defining a gear chamber, a differential gear set disposed in said gear chamber, and including at least one input gear and a pair of output gears defining an axis of rotation; a lock-up clutch operable to retard differentiating action, and actuating means for actuating said lock-up clutch; said lock-up clutch being operable between an engaged condition, effective to retard relative rotation between said gear case and said output gears, and a disengaged condition; said actuating means including cam mechanism operable to effect said engaged condition of said lock-up clutch, and retarding mechanism operable to engage said cam mechanism and retard rotation of one member of said cam means; characterized by:
said cam mechanism including a first cam member fixed to rotate with one of said output gears and a second cam member free to rotate relative to said first cam member and said output gear, the first cam member defining a first cam surface and the second cam member defining a second cam surface engagable with the first cam surface to impart movement of the second cam member along axis, said first cam member comprising a powdered metal component having a non-machined first cam surface.

2. A differential gear mechanism as claimed in claim 1, characterized by said first cam member being splined to said output gear.

3. A differential gear mechanism as claimed in claim 1, characterized by said retarding means comprising a flyweight mechanism rotatable about an axis oriented generally parallel to said axis of rotation, at a speed generally representative of the extent of said differentiating action, and defining a stop surface moveable from a retracted position to an extended position in response to a predetermined extent of differentiating action; said actuating means further including a latch surface disposed to engage said stop surface when said stop surface is in said extended position.

4. A differential gear mechanism as claimed in claim 3, characterized by said flyweight mechanism including a flyweight member defining said stop surface, said flyweight member defining a pivot portion defining a pivot axis parallel to and spaced apart from said axis of said flyweight mechanism, said stop surface being generally oppositely disposed from said pivot axis.
